(19) United States
(12) Patent Application Publication
(10) Pub. No.: US 2014/0089645 A1
(43) Pub. Date: Mar. 27, 2014

(54) PROCESSOR WITH EXECUTION UNIT INTEROPERATION

(71) Applicant: TEXAS INSTRUMENTS INCORPORATED, Dallas, TX (US)

(72) Inventors: Horst Diewald, Freising (DE); Johann Zipperer, Unterschleissheim (DE)

(73) Assignee: TEXAS INSTRUMENTS INCORPORATED, Dallas, TX (US)

(21) Appl. No.: 13/628,373

(22) Filed: Sep. 27, 2012

(51) Int. Cl. G06F 9/30

(52) U.S. Cl. 712/225; 712/E09.016

(57) ABSTRACT

A processor includes a plurality of execution units. Each of the execution units includes processing logic configured to process data, and registers accessible by the processing logic. At least one of the execution units is configured to execute a first instruction that causes the at least one execution unit to: route a value from a first register of the registers of one of the execution units to the processing logic of one of the execution units, to process the value in the processing logic to generate a result, and to store the result in a second register of the registers of one of the execution units. At least one of the first register, the second register, and the processing logic are located in a different one of the execution units from the at least one of the execution units.

### BACKGROUND

Microprocessors (processors) are instruction execution devices that are applied, in various forms, to provide control, communication, data processing capabilities, etc. to an incorporating system. Processors include execution units to provide data manipulation functionality. Exemplary execution units may provide arithmetic operations, logical operations, floating point operations etc. Processors invoke the functionality of the execution units in accordance with the requirements of the instructions executed by the processor.

### SUMMARY

A processor and execution unit providing instruction level execution unit interoperation are disclosed herein. In one embodiment, a processor includes a plurality of execution units. Each of the execution units includes processing logic configured to process data, and registers accessible by the processing logic. At least one of the execution units is configured to execute a first instruction that causes the at least one execution unit to: route a data value from a first register of the registers of one of the execution units to the processing logic of one of the execution units, to process the data value in the processing logic to generate a result, and to store the result in a second register of the registers of one of the execution units. At least one of the first register, the second register, and the processing logic are located in a different one of the execution units from the at least one of the execution units. The processing logic may include function logic and/or instruction execution logic of an execution unit.

In another embodiment, a processor includes a plurality of execution units. Each of the execution units includes a status register that includes fields for storing status values indicative of at least one of state and status of instruction execution. At least one of the execution units is configured to execute a first instruction that causes the at least one of the execution units to route a status value from a status register of a different one of the execution units to the at least one of the execution units, and to execute the first instruction based on the status value routed from the different one of the execution units.

In a further embodiment, a processor includes a plurality of execution units. Each of the execution units includes a status register that includes fields for storing status values indicative of at least one of state and status of instruction execution. At least one of the execution units is configured to execute a first instruction that causes the at least one of the execution units to store a status value generated by the at least one of the execution units, while executing the instruction, in the status register of a different one of the execution units.

### BRIEF DESCRIPTION OF THE DRAWINGS

For a detailed description of exemplary embodiments of the invention, reference will now be made to the accompanying drawings in which:

FIG. 1 shows a block diagram of a processor in accordance with various embodiments;

FIG. 2 shows a block diagram for an execution unit in accordance with various embodiments;

FIGS. 3A and 3B show interoperation between execution units in instruction execution in accordance with various embodiments;

FIGS. 4A-4D show instructions including fields that indicate execution units for interoperation in instruction execution in accordance with various embodiments;

FIG. 5 shows a block diagram of an execution unit executing an instruction in which status values are provided by execution units not executing the instruction in accordance with various embodiments;

FIG. 6 shows a block diagram a status multiplexer that selects status values of multiple execution units for use in an execution unit in accordance with various embodiments; and

FIGS. 7A-7B show instructions including fields that indicate execution units for interoperation of status information for an instruction being executed in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In conventional processor architectures, manipulation by a first execution unit of data stored in a second execution unit requires execution of instructions that transfer the data from the second to the first execution unit prior to execution of the manipulation instruction. Similarly, status used to determine program flow, instruction execution, etc., must be separately transferred to the execution unit executing a flow control or other status value based instruction. Requiring the execution of additional instructions to transfer data and/or status between execution units increases processor power consumption and program execution time and storage.

Embodiments of the processor disclosed herein include execution units that transfer data between different execution units for processing in accordance with specifications provided in a processing instruction. Accordingly, an instruction executed by a first execution unit may retrieve and process data stored in a second execution unit and store a result in a third execution. Similarly, instruction execution based on status values may selectively apply status of a plurality of execution units without first storing the status values in the execution unit executing the instruction. Thus, embodiments alleviate the need for execution of inter-execution unit data transfer instructions in conjunction with execution of a data manipulation instruction, thereby reducing processor power consumption and storage requirements and improving overall processing efficiency.

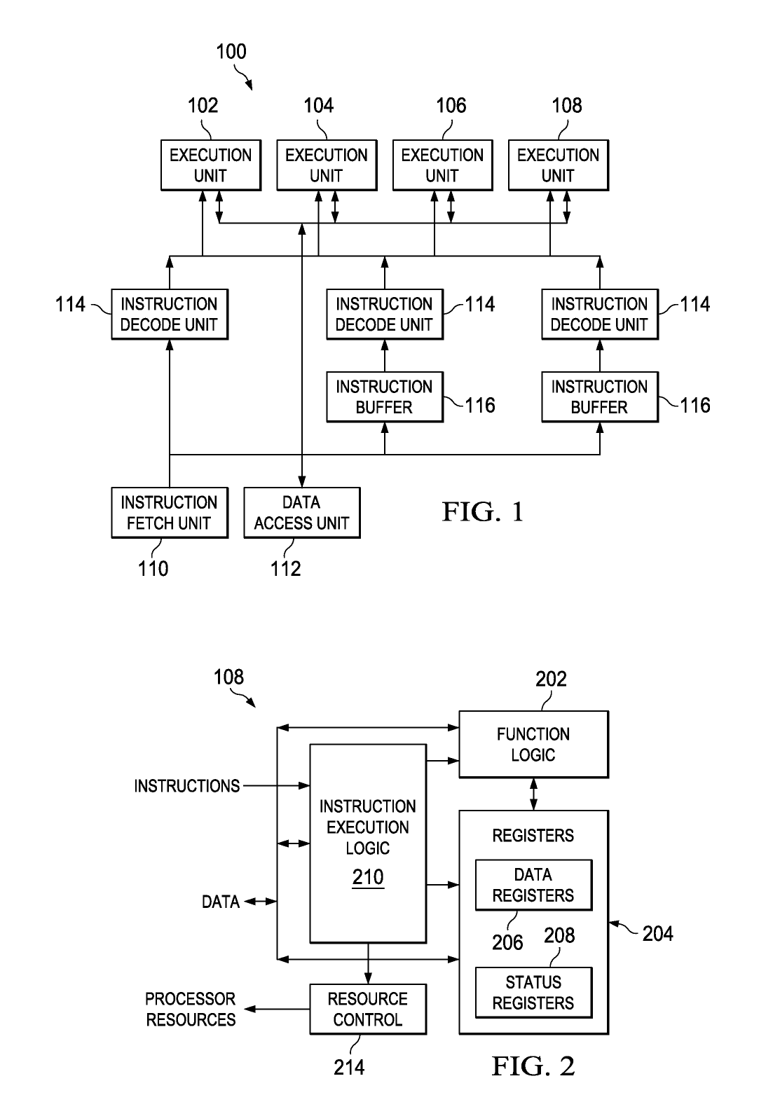

FIG. 1 shows a block diagram of a processor 100 in accordance with various embodiments. The processor 100 includes a plurality of execution units 102, 104, 106, 108. Other embodiments may include a different number of execution units. The processor 100 also includes an instruction fetch unit 110, a data access unit 112, and one or more instruction decode units 114. Some embodiments further include one or more instruction buffers 116. The processor 100 may also include other components and sub-systems that are omitted from FIG. 1 in the interest of clarity. For example, the processor 100 may include data storage resources, such as random access memory, communication interfaces and peripherals, timers, analog-to-digital converters, clock generators, debug logic, etc.

One or more of the execution units 102-108 can execute a complex instruction. For example, an execution unit (EU) 102-108 may be configured to execute a fast Fourier transform (FFT) instruction, execute a finite impulse response (FIR) filter instruction, an instruction to solve a trigonometric function, an instruction of evaluate a polynomial, an instruction to compute the length of a vector, etc. The execution units 102-108 allow complex instructions to be interrupted prior to completion of the instruction's execution. While an execution unit (e.g., EU 108) is servicing an interrupt, other execution units (EU 102-106) continue to execute other instructions. The execution units 102-108 may synchronize operation based on a requirement for a result and/or status generated by a different execution unit. For example, an execution unit 102 that requires a result value from execution unit 104 may stall until the execution unit 104 has produced the required result. One execution unit, e.g., a primary or core execution unit, may provide instructions to, or otherwise control the instruction execution sequence of, another execution unit.

To facilitate efficient execution of complex and other data manipulation and processing instructions, an execution unit 102-108 can access a different one or more of the execution units 102-108 as part of execution of the instruction. For example, in executing an instruction, the execution unit 106 may access operands stored in execution units 104 and 108, and store a result of processing the operands in execution unit 102. Similarly, the execution units 102-108 can execute status dependent instructions and instruction sequences based on status stored in different ones of the execution units 102-108. Thus, a status dependent program flow control instruction executed by the execution unit 102 can be predicated on status stored in execution unit 104, execution units 104, 106, etc. without requiring addition instructions to transfer the status to execution unit 102. To enable these operations, an instruction may include information that directly or indirectly indicates data and/or status source execution units, result destination execution units, execution unit to execute the instruction, etc.

The instruction fetch unit 110 retrieves instructions from storage (not shown) for execution by the processor 100. The instruction fetch unit 110 may provide the retrieved instructions to a decode unit 114. The decode unit 114 examines instructions, locates the various control sub-fields of the instructions, and generates decoded instructions for execution by the execution units 102-108. Instruction dispatch logic may be associated with the decode unit 114. As shown in FIG. 1, multiple execution units may receive decoded instructions from an instruction decoder 114. In some embodiments, an instruction decoder 114 may be dedicated to one or more execution units. Thus, each execution unit 102-108 may receive decoded instructions from an instruction decoder 114 coupled to only that execution unit, and/or from an instruction decoder 114 coupled to a plurality of execution units 102-108. Some embodiments of the processor 100 may also include more than one fetch unit 110, where a fetch unit 110 may provide instructions to one or more instruction decoder 114.

Embodiments of the processor 100 may also include one or more instruction buffers 116. The instruction buffers 116 store instructions for execution by the execution units 102-108. An instruction buffer 116 may be coupled to one or more execution units 102-108. An execution unit may execute instructions stored in an instruction buffer 116, thereby allowing other portions of the processor 100, for example other instruction buffers 116, the instruction fetch unit 110, and instruction storage (not shown), etc., to be maintained in a low-power or inoperative state. An execution unit may lock or freeze a portion of an instruction buffer 116, thereby preventing the instructions stored in the locked portion of the instruction buffer 116 from being overwritten. Execution of instructions stored in an instruction buffer 116 (e.g., a locked portion of an instruction buffer 116) may save power as no reloading of the instructions from external memory is necessary, and may speed up execution when the execution unit executing the instructions stored in the instruction buffer 116 is exiting a low-power state. An execution unit may call instructions stored in a locked portion of an instruction buffer 116 and return to any available power mode and/or any state or instruction location. The execution units 102-108 may also bypass an instruction buffer 116 to execute instructions not stored in the instruction buffer 116. For example, the execution unit 104 may execute instructions provided from the instruction buffer 116, instructions provided by the instruction fetch unit 110 that bypass the instruction buffer 116, and/or instructions provided by an execution unit 102, 106-108.

The instruction buffers 116 may also store, in conjunction with an instruction, control or other data that facilitate instruction execution. For example, information specifying a source of an instruction execution trigger, trigger conditions and/or trigger wait conditions, instruction sequencing information, information specifying whether a different execution unit or other processor hardware is to assist in instruction execution, etc. may be stored in an instruction buffer 116 in conjunction with an instruction.

The data access unit 112 retrieves data values from storage (not shown) and provides the retrieved data values to the execution units 102-108 for processing. Similarly, the data access unit 112 stores data values generated by the execution units 102-108 in a storage device (e.g., random access memory external to the processor 100, register of a peripheral device, etc.). Some embodiments of the processor 100 may include more than one data access unit 112, where each data access unit 112 may be coupled to one or more of the execution units 102-108.

The execution units 102-108 may be configured to execute the same instructions, or different instructions. For example, given an instruction set that includes all of the instructions executable by the execution units 102-108, in some embodiments of the processor 100, all or a plurality of the execution units 102-108 may be configured to execute all of the instructions of the instruction set. Alternatively, some execution units 102-108 may execute only a sub-set of the instructions of the instruction set. At least one of the execution units 102-108 is configured to execute a complex instruction that requires a plurality of instruction cycles to execute.

Each execution unit 102-108 is configured to control access to the resources of the processor 100 needed by the execution unit to execute an instruction. For example, each execution unit 102-108 can enable power to an instruction buffer 116 if the execution unit is to execute an instruction stored in the instruction buffer 116 while other instruction buffers, and other portions of the processor 100, remain in a low power state. Thus, each execution unit 102-108 is able to independently control access to resources of the processor 100 (power, clock frequency, etc.) external to the execution unit needed to execute instructions, and to operate independently from other components of the processor 100.

FIG. 2 shows a block diagram for an execution unit 108 in accordance with various embodiments. The block diagram and explanation thereof may also be applicable to embodiments of the execution units 102-106. The execution unit 108 includes function logic 202, registers 204, and instruction execution logic 210. The function logic 202 includes the arithmetic, logical, and other data manipulation resources for executing the instructions relevant to the execution unit 108. For example, the function logic may include adders, multipliers, shifters, logical functions, etc. for integer, fixed point, and/or floating point operations in accordance with the instructions to be executed by the execution unit 108.

The registers 204 include data registers 206 and status registers 208. The data registers 206 store operands to be processed by, and results produced by, the function logic 202. The data registers may also store addresses, control information, configuration information, etc. The number and/or size of registers included in the data registers 206 may vary across embodiments. For example, one embodiment may include 16 16-bit data registers, and another embodiment may include a different number and/or width of registers. The status registers 208 include one or more registers that store state information (condition codes) produced by operations performed by the function logic 202 and/or store instruction execution and/or execution unit state information. State information stored in a status register 208 may include a zero result indicator, a carry indicator, result sign indicator, overflow indicator, interrupt enable indicator, instruction execution state, etc.

The instruction execution logic 210 controls the sequencing of instruction execution in the execution unit 108. The instruction execution logic 210 may include one or more state machines that control the operations performed by the function logic 202 and transfer of data between the registers 204, the function logic 202, other execution units 102-106, the data access unit 112, and/or other components of the processor 100 in accordance with an instruction being executed. For example, the instruction execution logic 210 may include a state machine or other control device that sequences the multiple successive operations of a complex instruction being executed by the execution unit 108.

As part of sequencing instruction execution, the instruction execution logic 210 controls the access of data stored in different execution units (e.g., UEs 102-106). When the instruction execution logic 210 receives a given decoded instruction for execution, the instruction execution logic 210 may examine the instruction and determine operand source execution units and/or result destination execution units (i.e., determine execution unit/register associations). The source and/or destination execution unit may be the execution unit 108 executing the instruction or a different execution unit (102-106) of the processor 100. Having determined the source and/or destination execution units, the instruction execution logic 210 can retrieve the operands from the source execution units for manipulation by the function logic 202, and store the result generated by the function logic 202 in the destination execution unit.

When executing a status dependent instruction, the instruction execution logic 210 may examine the instruction and determine status value source execution units (i.e., determine execution unit/status register associations). The status value source execution units may include the execution unit 108 executing the instruction and/or a different execution unit (102-106) of the processor 100. Having determined the status value source execution units, the instruction execution logic 210 can retrieve the status values needed for execution of the instruction and proceed with instruction execution based on the retrieved status values. In accordance with the instruction, the instruction execution logic 210 may retrieve different types of status from different execution units. The instruction execution logic 210 may also store retrieved status values in one of the registers 206 and/or status registers 208 of an execution unit 102-108 in accordance with the instruction.

The execution unit 108 also includes resource control logic 214. The resource control logic 214 requests access to the various resources (e.g., storage, power, clock frequency, etc.) of the processor 100 that the execution unit 108 uses to execute an instruction. By requesting processor resources independently for each execution unit 102-108, the power consumed by the processor 100 may be reduced by placing only components of the processor 100 required for instruction execution by an active execution unit 102-108 in an active power state. Furthermore, execution units 102-108 not executing instructions may be placed in a low-power state to reduce the power consumption of the processor 100.

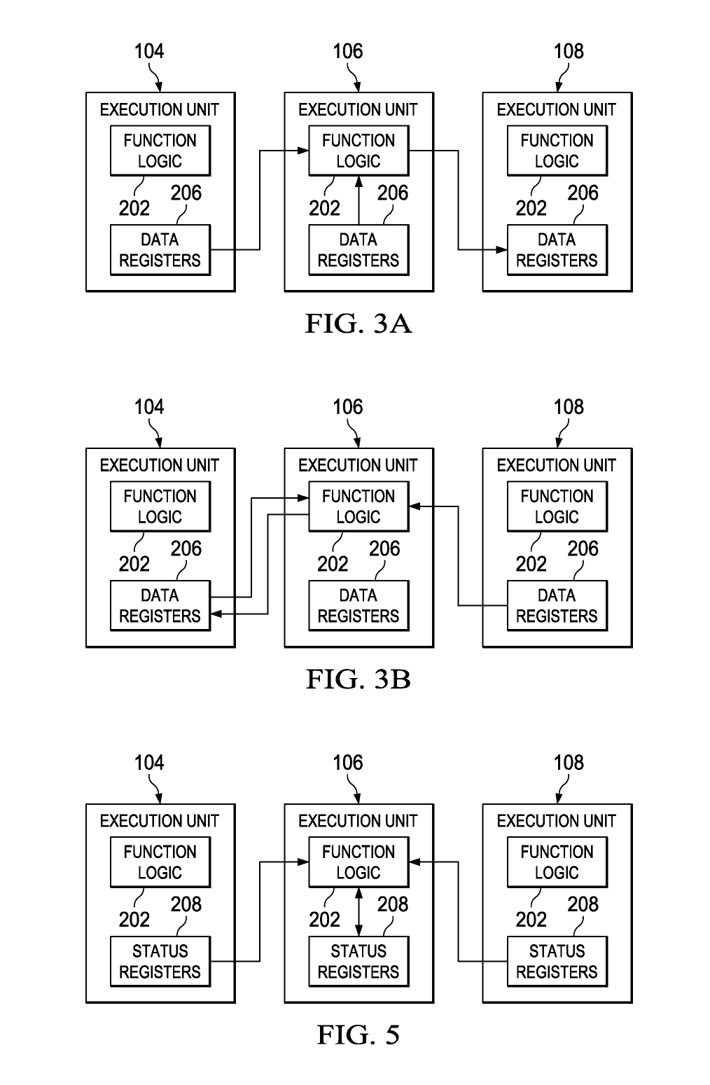

Generally, the execution units 102-108 of the processor 100 may interoperate during execution of an instruction to share data and functionality without requiring additional instructions for data movement, etc. FIGS. 3A and 3B show interoperation between execution units in instruction execution in accordance with various embodiments. In FIG. 3A, an instruction is being executed that directs application of the function logic 202 of the execution unit 106 to operands stored in the registers 206 of the execution units 104 and 106. The instruction further directs that a result of processing by the function logic 202 of the execution unit 106 be stored in the registers 206 of the execution unit 108. Accordingly, execution of the instruction causes the transfer of an operand from the execution unit 104 to the execution unit 106, processing of the operand in conjunction with the operand provided from the execution unit 106, and provision of a result of processing to the execution unit 108 for storage. For example, the execution unit 106 may retrieve a first operand from one of the registers 206 of execution unit 104, add the first operand to a second operand retrieved from the registers 206 of execution unit 106, and store the sum in one of the registers 206 of the execution unit 108.

In FIG. 3B, an instruction is being executed that directs application of the function logic 202 of the execution unit 106 to operands stored in the registers 206 of the execution units 104 and 108. The instruction further directs that a result of processing by the function logic 202 of the execution unit 106 be stored in one of the registers 206 of the execution unit 104. Accordingly, execution of the instruction causes the transfer of operands from execution units 104 and 108 to the execution unit 106, processing of the operands in the execution 106, and provision of a result of processing to the execution unit 104 for storage. For example, the execution unit 106 may retrieve a first operand from one of the registers 206 of execution unit 104, retrieve a second operand from one of the registers 206 of execution unit 108, add the first operand and the second operand, and store the sum in one of the registers 206 of the execution unit 104. Embodiments of the processor 100 support numerous variations of such instruction level selection of data and functions for interoperation between execution units 102-108.

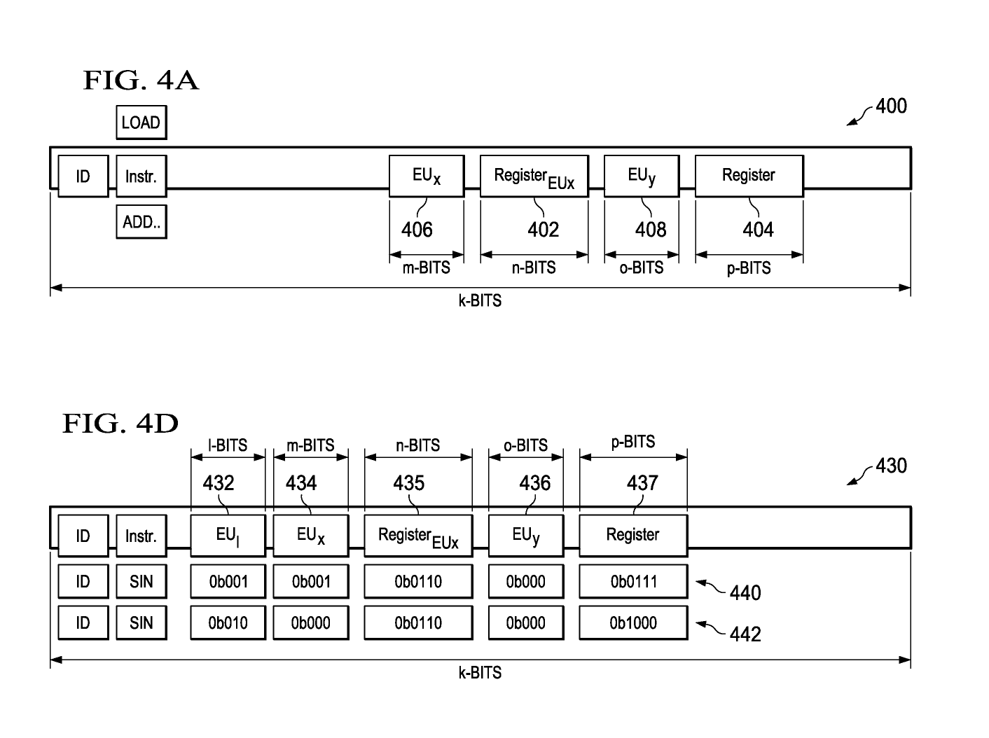

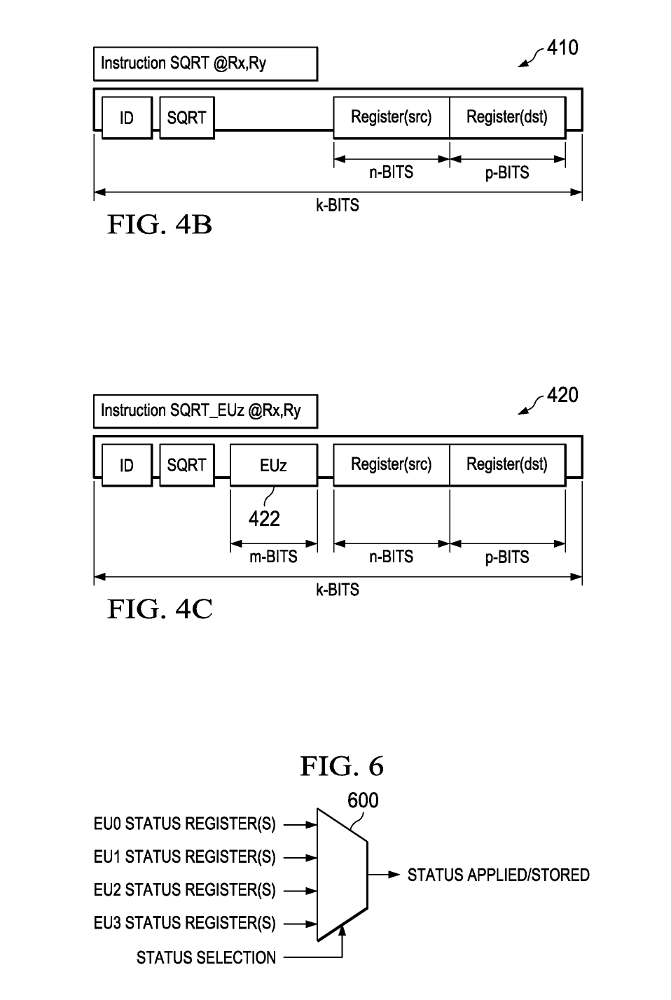

An instruction may convey, in a variety of ways, to the instruction execution logic 210, interoperation information indicative of which execution units are to be used as a data source, data destination, and/or function source for the instruction to be executed. More specifically, an instruction may directly (e.g., via immediate instruction values) or indirectly (via a location of information specified in the instruction) convey execution unit interoperation information. FIGS. 4A-4D show instructions including fields that indicate execution units for interoperation in instruction execution in accordance with various embodiments. The instruction 400 shown in FIG. 4A includes fields 402 and 404 that specify the use of two registers. The registers may be operand source or result destination registers. The instruction 400 also includes execution unit specification fields 406 and 408 that correspond respectively to the register specification fields 402 and 404. The execution unit specification field 406 indicates which execution unit 102-108 contains the register specified in field 402, and the execution unit specification field 408 indicates which execution unit 102-108 contains the register specified in field 404. The instruction execution logic 210 extracts information from the fields 402-408 and transfers data to and/or from the indicated registers of the indicated execution units 102-108 in accordance with the instruction. The number of execution unit specification fields included in an instruction can vary from instruction to instruction.

In some embodiments, designation of execution unit/register association (i.e., which execution unit contains a specified register) is effective for execution of the instruction defining the association and/or for execution of one or more additional instructions. The instruction execution logic 210 may apply predetermined execution unit/register associations in execution of some instructions. The instruction 410 shown in FIG. 4B lacks express execution unit/register association information. Consequently, the instruction execution logic 210 may apply predetermined execution unit/register associations defined via a previously executed instruction or a default association (e.g., a default register set, registers of execution unit executing the instruction, etc.).

The instruction 420 shown in FIG. 4C includes an execution unit designation field 422 that provides information specifying which execution unit 102-108 is to execute the instruction. The instruction execution logic 210 may associate registers with execution units based on information provided via the field 422 (e.g., associate the execution unit executing the instruction with the registers designated in the instruction). Alternatively, the instruction execution logic 210 may apply predetermined execution unit/register associations defined via a previously executed instruction or a default association.

The instruction 430 shown in FIG. 4D includes an execution unit designation field 432 and execution unit/register association fields 434 and 436. The execution unit designation field 432 specifies which execution unit 102-108 is to execute the instruction. The execution unit/register association field 434 indicates which execution unit 102-108 contains the register designated by field 435, and execution unit/register association field 436 indicates which execution unit 102-108 contains the register designated by field 437.

Field value specifications 440 and 442 of FIG. 4D show that the instruction 430 may, in one embodiment, be a sine computation instruction executable by a first execution unit in specification 440 and by a second execution unit in specification 442. The specifications 440, 442 indicate use of different execution unit/register associations in the respective sine computations.

In addition to interoperability with regard to data registers 206, embodiments of the execution units 102-108 interoperate with regard to stored status. Thus, execution of an instruction by a first execution unit may be dependent on status values stored in different execution units without requiring additional instructions for movement of the status to the first execution unit. FIG. 5 shows a block diagram of an execution unit 106 executing an instruction in which status values are provided by execution units 104, 108 in accordance with various embodiments. In FIG. 5, execution unit 106 is executing an instruction that references status. The instruction may be a conditional branch or jump, a conditionally executed instruction, or another instruction whose execution requires referencing of stored status information. In FIG. 5, the instruction being executed by the execution unit 106 references status values stored in the status registers 208 of the execution units 104 and 108. Accordingly, in executing the instruction, the execution unit 106 retrieves the status values specified by the instruction from the execution units 104, 108 and applies the retrieved status values to execute the instruction. Some embodiments may store the retrieved status values in a register 206 or a status register 208 of the execution unit 106 or a different execution unit.

FIG. 6 shows a block diagram a status multiplexer 600 that selects status values of multiple execution units for use in an execution unit in accordance with various embodiments. The multiplexer 600 selects from status values provided from the status register(s) 208 of a plurality of the execution units 102-108 (e.g., all of the execution units 102-108) based on a status selection signal, and provides the selected status values to an execution unit. An instance of the multiplexer 600 may be included in or associated with each of the execution units 102-108. The multiplexer 600 may provide a plurality of status value outputs corresponding to the different status types stored in the status registers 208.

Status selection control provided to the multiplexer can be generated at the instruction level as described below. In some embodiments, the status selection control may be provided from a register that stores a predetermined selection value. For example, the predetermined selection value may be a default value (e.g., the execution unit which the multiplexer 600 provides a status output and/or a most commonly used status register), or may be loaded by execution of an instruction that provides a status selection value.

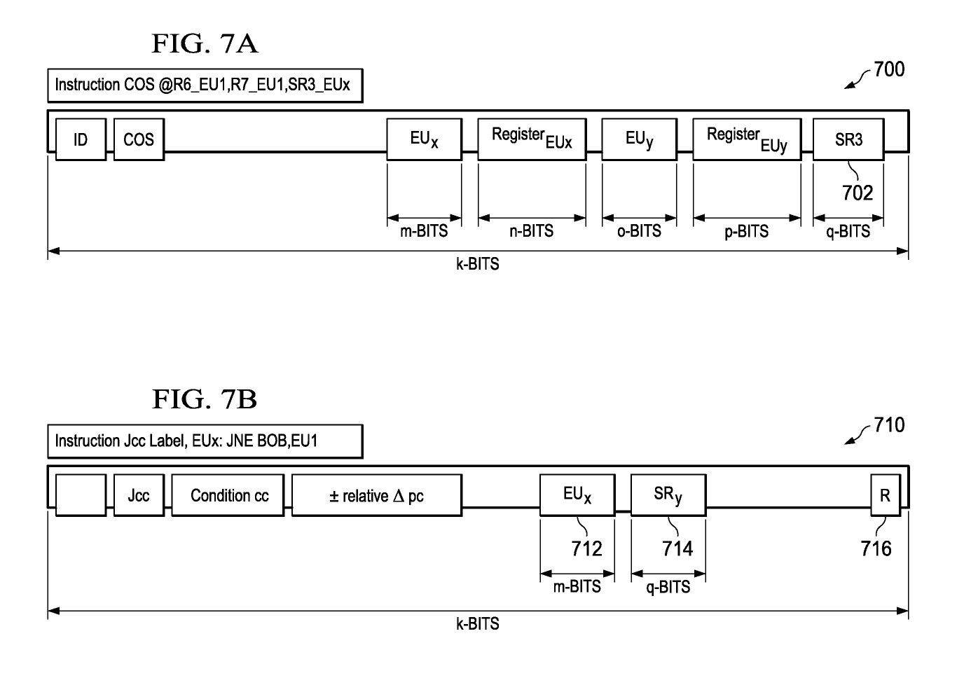

An instruction may convey, in a variety of ways, to the instruction execution logic 210, interoperation information indicative of which execution units are to be used as a source of status information for the instruction being executed. More specifically, an instruction may directly or indirectly convey execution unit status interoperation information. FIG. 7A-7B show instructions including fields that indicate execution units for interoperation of status information for an instruction being executed in accordance with various embodiments. The instruction 700 shown in FIG. 7A includes a status selection field 702 that indicates which status register and/or which status values are to be applied in a subsequent conditional instruction, such as a conditional branch instruction, etc. The execution unit containing the status register may be specified by the field 702, a different field of the instruction 700, a predetermined execution unit/register association, etc.

The instruction 710 of FIG. 7B is a conditional instruction, the execution of which is dependent on one or more status values. The instruction 710 includes fields 712, 714, and 716. Field 714 directly or indirectly indicates a status register 208 that contains the status value(s) to be considered for execution of the instruction 710. Field 712 directly or indirectly indicates an execution unit 102-108 that contains the status register indicated via field 214. Field 714 indicates whether the status values of register and execution unit indicated via fields 714 and 712 is to replace an equivalent status value in a status register and/or store the status value in a different register of the execution unit executing the instruction 710. Alternatively, the status value indicated via the instruction may be stored in a different execution unit from the execution unit that is executing the instruction. Various embodiments of an instruction executable by the execution units 102-108 may include one or more of the fields 712-716 to designate a particular execution unit, status register, and status value replacement. In some embodiments, the instruction execution logic 210 may derive one or more values specified by the fields 712-716 from one or more different fields of the instruction, such as ID, opcode, etc.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A processor, comprising:
a plurality of execution units, each of the execution units comprising:
processing logic configured to process data; and
registers accessible by the processing logic;
wherein at least one of the execution units is configured to:
execute a first instruction that causes the at least one execution unit to:
route a value from a first register of the registers of one of the execution units to the processing logic of one of the execution units;
process the value in the processing logic to generate a result; and
store the result in a second register of the registers of one of the execution units;
wherein at least one of the first register, the second register, and the processing logic are located in a different one of the execution units from the at least one of the execution units.

2. The processor of claim 1, wherein the first instruction indicates:
which of the execution units contains the first register; and
which of the execution units contains the second register.

3. The processor of claim 1, wherein the first instruction indicates which of the execution units contains the processing logic.

4. The processor of claim 1, wherein the first instruction indicates that the processing logic is located in a different one of the execution units from the at least one execution unit.

5. The processor of claim 1, wherein the first instruction comprises a field specifying at least one of
indicia of the different one of the execution units;
indicia of a location of information specifying the different one of the execution units;
indicia of one of the execution units containing the processing logic; and
indicia of a location of information specifying one of the execution units containing the processing logic.

6. The processor of claim 1, wherein each of the execution units comprises a status register comprising fields for storing status values indicative of status of instruction execution; wherein a given one of the execution units is configured to execute a second instruction that causes the given one of the execution units to:
route a status value from a status register of a different one of the execution units; and
execute the second instruction based on the status value routed from the different one of the execution units.

7. The processor of claim 6, wherein the second instruction comprises a field specifying at least one of:
the different one of the execution units containing the status value;
one of a plurality of status registers of the different one of the execution units containing the status value;
indicia of a location storing information specifying the different one of the execution units containing the status value; and
indicia of a location storing information specifying the one of the plurality of status registers of the different one of the execution units containing the status value.

8. The processor of claim 6, wherein the second instruction causes the given execution unit to store the status value routed from the status register of the different one of the execution units in the status register of the given one of the execution units.

9. The processor of claim 1, wherein each of the execution units comprises a status register comprising fields for storing status values; wherein a given one of the execution units is configured to execute a second instruction that causes the given one of the execution units to store a status value generated by the given execution unit while executing the second instruction in the status register of a different one of the execution units; wherein the status value is indicative of at least one of state and status of instruction execution.

10. The processor of claim 9, wherein the second instruction comprises a field specifying at least one of:
the different one of the execution units to which to store the status value;
one of the plurality of status registers of the different one of the execution units to which to store the status value;
indicia of a location storing information specifying the different one of the execution units to which to store the status value; and
indicia of a location storing information specifying the one of the plurality of status registers of the different one of the execution units to which to store the status value.

11. A processor, comprising:
a plurality of execution units, each of the execution units comprising a status register comprising fields for storing status values indicative of at least one of state and status of instruction execution; wherein at least one of the execution units is configured to execute a first instruction that causes the at least one of the execution units to:
route a status value from a status register of a different one of the execution units to the at least one of the execution units; and
execute the first instruction based on the status value routed from the different one of the execution units.

12. The processor of claim 11, wherein the first instruction comprises a field specifying at least one of:
the different one of the execution units containing the status value;
one of a plurality of status registers of the different one of the execution units containing the status value;
indicia of a location storing information specifying the different one of the execution units containing the status value; and
indicia of a location storing information specifying the one of the plurality of status registers of the different one of the execution units containing the status value.

13. The processor of claim 11, wherein the first instruction causes the at least one of the execution units to store the status value routed from the status register of the different one of the execution units in the status register of the at least one of the execution units.

14. The processor of claim 1, wherein at least one of the execution units is configured to execute an instruction that causes the at least one of the execution units to store a status value generated by the at least one of the execution units, while executing the instruction, in the status register of a different one of the execution units.

15. The processor of claim 14, wherein the instruction comprises a field specifying at least one of:
the different one of the execution units to which to store the status value;
one of the plurality of status registers of the different one of the execution units to which to store the status value;
indicia of a location storing information specifying the different one of the execution units to which to store the status value; and
indicia of a location storing information specifying the one of the plurality of status registers of the different one of the execution units to which to store the status value.

16. The processor of claim 11, wherein each of the execution units comprises:
processing logic configured to process data; and
registers configured to store data;
wherein a given one of the execution units is configured to:
execute a second instruction that causes the given one of the execution units to:
route a source data value from a register of a different one of the execution units to a processing logic;
manipulate the source data value in the processing logic to produce a result; and
store the result produced by the processing logic in a register of one of the execution units.

17. The processor of claim 16, wherein the second instruction specifies at least one of:
the different one of the execution units from which the source data value is routed; and
which of the execution units contains the processing logic.

18. The processor of claim 16, wherein the second instruction specifies that the processing logic is in a different one of the execution units from the at least one of the execution units.

19. The processor of claim 16, wherein the second instruction comprises a field specifying at least one of
indicia of the different one of the execution units;
indicia of a location of information specifying the different one of the execution units;
indicia of one of the execution units containing the processing logic; and
indicia of a location of information specifying one of the execution units containing the processing logic.

20. A processor, comprising:
a plurality of execution units, each of the execution units comprising a status register comprising fields for storing status values indicative of at least one one state and status of instruction execution by the execution unit;
wherein at least one of the execution units is configured to execute a first instruction that causes the at least one of the execution units to store a status value generated by the at least one of the execution units, while executing the instruction, in the status register of a different one of the execution units.

21. The processor of claim 20, wherein the first instruction comprises a field specifying at least one of
indicia of the different one of the execution units; and
indicia of a location of information specifying the different one of the execution units.

22. The processor of claim 20, wherein at least one of the execution units is configured to execute a second instruction that causes the at least one of the execution units to:
route a status value from a status register of a different one of the execution units to the at least one execution unit; and
execute the second instruction based on the status value routed from the different one of the execution units.

23. The processor of claim 22, wherein the second instruction comprises a field specifying at least one of:
the different one of the execution units containing the status value;
one of a plurality of status registers of the different one of the execution units containing the status value;
indicia of a location storing information specifying the different one of the execution units containing the status value; and
indicia of a location storing information specifying the one of the plurality of status registers of the different one of the execution units containing the status value.

24. The processor of claim 22, wherein the second instruction causes the at least one execution unit to store the status value routed from the status register of the different one of the execution units in the status register of the at least one of the execution units.

25. The processor of claim 20, wherein each of the execution units comprises:
processing logic configured to process data; and
registers configured to store data;
wherein a given one of the execution units is configured to:
execute a second instruction that causes the given one of the execution units to:
route a source data value from a register of a different one of the execution units to a processing logic;
manipulate the source data value in the processing logic to produce a result; and
store the result produced by the processing logic in a register of one of the execution units.

26. The processor of claim 25, wherein the second instruction specifies at least one of:
the different one of the execution units from which the source data value is routed; and
which of the execution units contains the processing logic.

27. The processor of claim 25, wherein the second instruction specifies that the processing logic is in a different one of the execution units from the given one of the execution units.
